(19) United States
(12) Patent Application Publication
(10) Pub. No.: US 2025/0348741 A1
(43) Pub. Date: Nov. 13, 2025

(54) AUTOMATIC LABEL GENERATION WITH CONFIDENCE SCORES FOR TRAINING A MACHINE LEARNING MODEL TO PERFORM LINE ITEM EXTRACTION

(71) Applicant: INTUIT INC., Mountain View, CA (US)

(72) Inventors: Tharathorn RIMCHALA, San Francisco, CA (US); Karelia Del Carmen PENA-PENA, Wilmington, DE (US); Preeti DURAIPANDIAN, Plano, TX (US); Shir MEIR LADOR, Givat Shmuel (IL)

(21) Appl. No.: 18/657,190

(22) Filed: May 7, 2024

(51) Int. Cl. G06N 3/09; G06V 30/414

(52) U.S. Cl. CPC G06N 3/09; G06V 30/414

(57) ABSTRACT

Aspects of the present disclosure provide techniques for training an item extraction machine learning model. Embodiments include extracting text and bounding box coordinates from a structured document and creating structured text by adjusting formatting of the extracted text based on the extracted bounding box coordinates and adding table delimiter tags to the extracted text based on detecting one or more tables in the structured document. Embodiments include providing the structured text to a language processing machine learning model along with a prompt instructing the language processing machine learning model to generate a label indicating variables present in the structured text and values for the variables. Embodiments include receiving the label from the language processing machine learning model in response to the structured text and the prompt and training the item extraction machine learning model through a supervised learning process based on training data comprising the structured text and the label.

### INTRODUCTION

Aspects of the present disclosure relate to techniques for training an item extraction machine learning model. In particular, techniques described herein involve utilizing a language processing machine learning model such as a unimodal large language model (LLM) and optimized prompts to generate labeled training data based on text, positional, and table data extracted from a structured document. Techniques described herein further relate to utilizing artificial intelligence (AI) generated labeled training data with confidence scores to train an item extraction model through a noise-aware supervised learning process that takes into account confidence scores from the label generation process, the structure of the generated text, and the potential for hallucinations that could arise from the item extraction model predictions. These unique aspects of the supervised instruction fine-tuning of the item extraction model may be expressed as separate terms in an objective function used to train or fine-tune the item extraction model, which is iteratively optimized during such training or fine-tuning.

### BACKGROUND

Every year millions of people, businesses, and organizations around the world utilize software applications to assist with countless aspects of life. In some cases, a software application may automatically extract information from electronic documents, such as for use in application workflows. For example, records of transactions may be extracted from structured documents and used by a software application to perform functionality related to transaction reconciliation. However, there are several technical challenges associated with automatic extraction of information from structured documents. For instance, structured documents may have variable formats and lengths, variable numbers of tables and variable numbers of line items in such tables to be extracted, differing column names and ordering across documents, multiple tables in a single document, varying templates, and/or the like.

These format and content variations across structured documents make it challenging to automatically extract information from such documents using traditional rule based and/or structure based approaches. While some existing techniques involve training a machine learning model to perform automated information extraction from structured documents, these techniques generally do not function well without acquiring and using large amounts of labeled training data. Acquiring ground truth labels for large numbers of structured documents of varying formats at the individual line item level is extremely costly in resources, labor, and time, and is an error-prone process due to the large amounts of data that must be reviewed and labeled with such techniques. Thus, training and using machine learning models to accurately extract information from structured documents is often impractical using existing techniques. Furthermore, even when labeled training data is obtained and used to train such a model using existing techniques, the trained model may frequently produce inaccurate results due to problems such as insufficient format variation coverage in the training data relative to the large amounts of variation in format and content between structured documents, label errors in training data, model hallucinations (e.g., model predictions of key information entities values that are not present in the documents, such as due to greedy autoregressive decoding of extraction models that rely on decoder architectures and/or erroneous patterns otherwise learned by the model), and/or the like.

As such, there is a need in the art for improved techniques of training machine learning models for extracting information from structured documents.

### BRIEF SUMMARY

Certain embodiments provide a method for training an item extraction machine learning model. The method generally includes: extracting text and bounding box coordinates from a structured document; creating structured text by adjusting formatting of the extracted text based on the extracted bounding box coordinates and adding table delimiter tags to the extracted text based on detecting one or more tables in the structured document; providing the structured text to a language processing machine learning model along with a prompt instructing the language processing machine learning model to generate a label indicating variables present in the structured text and values for the variables; receiving the label from the language processing machine learning model in response to the structured text and the prompt; and training the item extraction machine learning model through a supervised learning process based on training data comprising the structured text and the label.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example workflow for automatic generation of labeled training data for training an item extraction machine learning model, according to embodiments of the present disclosure.

FIG. 2 depicts an example workflow for using automatically generated labeled training data to train an item extraction machine learning model through a supervised learning process that prevents model hallucinations and encourages structured output corresponding to a pre-defined schema, according to embodiments of the present disclosure.

FIG. 3 depicts an example workflow for automatically generating structured text in connection with using automatically generated labeled training data to train an item extraction machine learning model, according to embodiments of the present disclosure.

FIG. 4 depicts example operations related to training an item extraction machine learning model, according to embodiments of the present disclosure.

FIG. 5 depicts an example processing system for performing functionality related to training an item extraction machine learning model, according to embodiments of the present disclosure herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for training an item extraction machine learning model, according to embodiments of the present disclosure.

Training a machine learning model to extract information from structured documents generally involves acquiring large amounts of accurate labeled training data that is representative of the many variations in format and content that are possible in such documents. However, existing techniques for acquiring such labeled training data involve human-in-the-loop reviewing and labeling of large amounts of documents at the line item level, which is a lengthy, costly, and error-prone process. Accordingly, existing machine learning models trained to extract information from structured documents are generally limited in accuracy due to limited amounts and insufficient variation in training data relative to the large amounts of variation in format and content between structured documents, errors in training data, model hallucinations (e.g., model predictions of extracted information that is not present in the source document), and/or the like.

Techniques described herein overcome these challenge through a dynamic process for automatically generating labeled training data based on layout-aware processing of structured documents, and using this automatically generated labeled training data to train a lightweight or compact item extraction machine learning model through a supervised learning process that discourages model hallucinations through particular loss terms in an objective function. Thus, embodiments of the present disclosure allow an item extraction machine learning model to be trained for accurate extraction of line items based on a large-scale training data set that is representative of many variations in format and content between structured documents and that is efficiently generated.

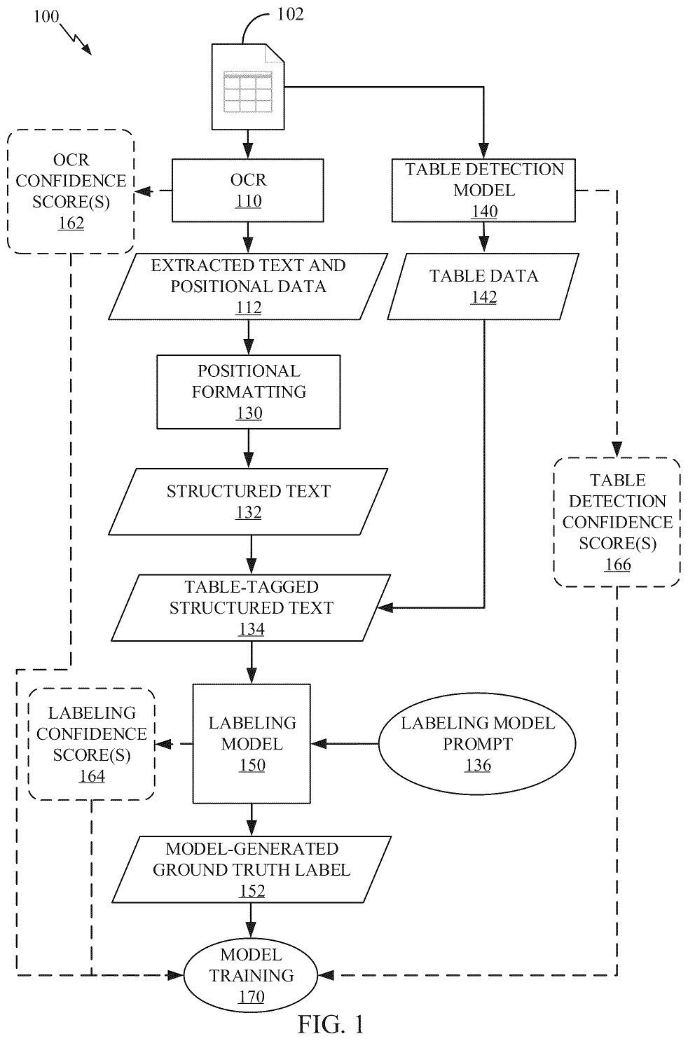

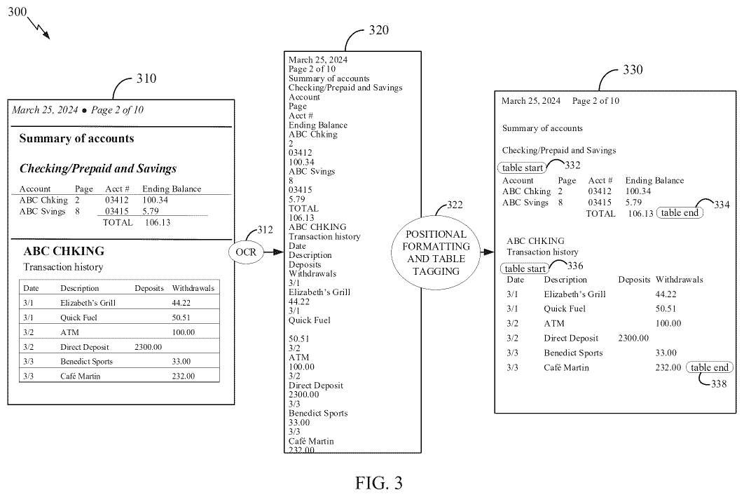

As described in more detail below with respect to FIG. 1, an automatic labeled training data generation process may involve extracting text and positional data from a structured document using optical character recognition (OCR). As described in more detail below with respect to FIG. 3, the raw text extracted using OCR may then be reformatted according to the two-dimensional positional data extracted using OCR to reproduce two-dimensional positional spacing in a one-dimensional text sequence that corresponds to the structure of the original structured document. Furthermore, a table extraction machine learning model may be used to locate tables and recognize the detailed tabular structures in the structured document, such as the coordinates of any tables present in the document, and tags may be added to the structured text based on the table information, such as adding special table start table end token pairs designating the start and the end of individual tables within the structured text, such as indicating where tables start and end relative to the text, as described in more detail below with respect to FIG. 3.

The structured text with table start and end tag pairs may be provided to a natural language processing machine learning model, such as a large language model (LLM), along with a natural language prompt. The prompt may instruct the natural language processing machine learning model to generate a label (e.g., structured text output corresponding to a pre-defined schema that specifies key information) based on the structured text, such as specifying the schema along with the list of key information entities to be extracted from the structured text. The prompt may also include additional context and/or rules to assist the natural language processing machine learning model with the label generation process.

The natural language processing machine learning model may output a label based on structured text in response to the prompt. For example, the label may indicate one or more variables and corresponding values extracted from the structured text according to the instructions in the prompt. The structured text with table tags may allow the natural language processing machine learning model to perform extraction with a higher level of accuracy compared to the raw OCR text, as natural language processing machine learning models are generally trained to recognize contextual clues that are based on the way text is structured.

The label output by the natural language processing machine learning model may then be used to generate a labeled training data instance for use in training an item extraction machine learning model. For example, the item extraction machine learning model may be a compact (e.g., compute friendly), more task-specific machine learning model than the natural language processing machine learning model, such as having fewer tunable parameters compared to the label generating natural language processing machine learning model and being trained or fine-tuned for particular item extraction tasks. Thus, labels generated using the high capacity, more domain-general natural language processing machine learning model may be used to train or fine-tune the smaller, more focused item extraction machine learning model through a supervised learning process for accurate, resource-efficient item extraction from structured documents.

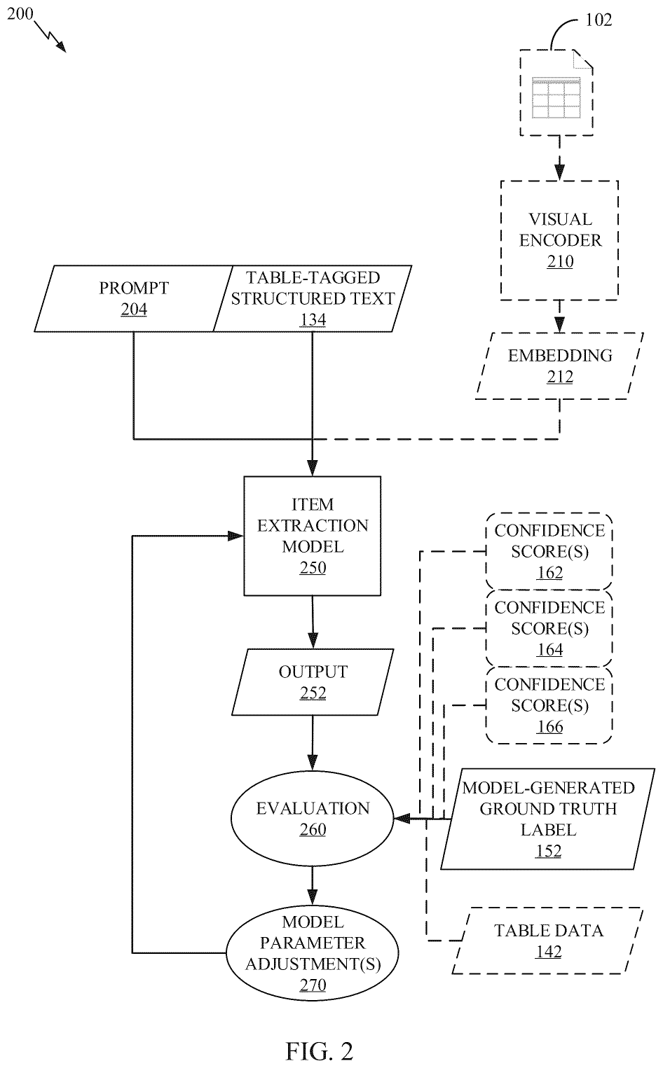

However, because the labels are automatically generated using the natural language processing machine learning model, the truthfulness of the labels may be unconfirmed. Accordingly, as described in more detail below with respect to FIGS. 1 and 2, confidence scores associated with the text and positional data extracted using OCR, the table data extracted using the table extraction model, and/or the label generated by the natural language processing model may be used as measures of label reliability during the training process. For example, an aggregation of one or more such confidence scores may be used to determine whether a given label meets a threshold level of confidence to be used as training data. Furthermore, one or more such confidence scores may be used during training of the item extraction machine learning model, such as to weight (e.g., in terms of loss computed by an objective function) training data instances with higher-confidence labels more highly than training data instances with lower-confidence labels when training the model.

Additionally, as described in more detail below with respect to FIG. 2, training of the item extraction machine learning model may be a noise-aware training process. Additionally, to prevent hallucinations, an avoidance loss term may be used as an additional term in the objective function. For example, an objective function used to train the model may penalize extracted results that do not correspond to a schema (e.g., a key value set or tabular structured output with an ordered list of expected variables to be included in a label), and/or may penalize extracted results that are not present within a table in the structured document.

An example training process involves providing structured text with table tags along with a prompt to the item extraction machine learning model. The prompt may be smaller, more compact, and less descriptive than the prompt provided to the label generating natural language processing machine learning model. In some embodiments, a multimodel (e.g., image and text) embedding (e.g., vector representation) of the structured document may also be provided to the item extraction machine learning model so that the model learns to generate the structured output (labels) from the latent representation in the inputs. The item extraction machine learning model may process the inputs through its layers and may output natural language text. The output may then be compared to the label associated with the structured text in the training data (e.g., the label generated by the natural language processing machine learning model) in order to determine an accuracy of the item extraction machine learning model. The comparison may involve evaluating an objective function that considers correspondence between the output and the label, one or more confidence scores associated with the label, whether the output conforms to a schema (e.g., indicated in the label), whether individual values in the output are contained in one or more tables in the structured document, and/or the like. Parameters of the item extraction machine learning model may then be adjusted based on the evaluating of the objective function, such as iteratively to minimize the computed loss and thereby improve accuracy of the model predictions.

Once trained, the item extraction machine learning model is a lightweight, accurate model that can be used to extract items from structured documents with various formats and content. For example, the trained model may be used to accurately extract details of transactions from a structured document that includes records of such transactions, and the extracted transaction details may be used to perform downstream tasks in a software application, such as transaction reconciliation tasks.

Embodiments of the present disclosure provide multiple improvements over conventional techniques for training machine learning models to extract information from documents. For example, by utilizing a natural language processing machine learning model to automatically generate labels for structured documents based on structured text from such structured documents, techniques described herein allow large amounts of training data representative of the many variations in format and content that are possible in structured documents to be generated more efficiently than with existing techniques that involve individual review and labeling of many structured documents at the line-item level. Furthermore, by utilizing structured text with table start and table end tags as input to the natural language processing machine learning model, rather than only the raw text extracted using OCR, techniques described herein enable the natural language processing model to more effectively leverage the textual and structural context of the input data and thereby more accurately extract information for label generation. By specifying contextual information and/or instructions in a natural language prompt provided to the natural language processing machine learning model along with the structured text, such as specifying a structured object format to which an output label is to correspond, embodiments of the present disclosure enable more targeted and accurate labels to be automatically generated.

Once labeled training data is automatically generated as described herein, certain embodiments provide further technical improvements to a supervised learning process for using the labeled training data to train an item extraction machine learning model. For example, by using confidence scores associated with various aspects of the automatic label generation process to determine whether to use individual training data instances in a training process, such as filtering out training data instances having labels with confidence scores below a threshold, techniques described herein avoid the computing resource utilization that would otherwise occur in connection with using low-confidence training data to train the item extraction machine learning model, and avoid the model inaccuracies that would otherwise result from using such low-confidence training data in the training process. Furthermore, by utilizing confidence scores associated with the automatic label generation process in a noise-aware training process, such as to weight the loss associated with high-confidence training data instances more highly in the training process than the loss associated with low-confidence training data instances, techniques described herein improve the accuracy of the resulting trained item extraction machine learning model by reducing the effect of low-confidence training data on the training process while increasing the effect of high-confidence training data on the model parameter updates. Additionally, by training the item extraction machine learning model in a schema-aware and/or table-aware manner (e.g., through the use of an objective function that computes loss based on conformity of the model predictions to a schema specified in the label and/or based on whether model outputs are present within tables in the input document), techniques described herein further improve model accuracy and prevent model hallucinations by nudging the model toward producing outputs that conform to an expected format and/or that are extracted from expected locations within the input document.

Furthermore, using embeddings of structured documents as inputs during training of the item extraction machine learning model enables the item extraction model to learn latent representations based on the contextual information, the semantic meaning, and the structure of the input, and thereby enable to the item extraction machine learning model to apply insights gained from one structured document to other structured documents that are semantically similar to that structured document even when the model has not been specifically trained for extracting information from those other structured documents. Thus, techniques described herein allow the item extraction machine learning model to further account for the many variations in format and content that are possible between structured documents without necessarily having labeled training data instances that directly correspond to each such variation.

Training a more compact and more domain-specific item extraction machine learning model based on labeled training data generated using a higher-capacity, more domain-general language processing machine learning model allows relevant insights of such a larger model (e.g., gained through an extensive training process based on large amounts of natural language training data from many domains) to be distilled in a task-specific manner to a lightweight machine learning model that can be executed in a resource-efficient manner for targeted and accurate extraction of information from structured documents. Therefore, techniques described herein reduce computing resource utilization (e.g., at runtime) and thereby improve the functioning of computing applications and devices involved while also improving technical accuracy.

### Automated Generation of Labeled Training Data for an Item Extraction Machine Learning Model

FIG. 1 depicts an example workflow 100 for automatic generation of labeled training data for training an item extraction machine learning model, according to embodiments of the present disclosure.

Structured document 102 represents an electronic document, such as a form, statement, report, list, spreadsheet, or other type of electronic document in which data is structured, such as in one or more tables. Structured document 102 may include machine readable text or may include text that is not in a machine readable form, such as if structured document 102 is in the form of an image or other type of document format that does not include machine-readable text.

In some embodiments, a plurality of structured documents are processed in a similar manner to that shown with respect to structured document 102 in order to generate a training data set for training an item extraction machine learning model (training of such a model using such a training data set is described below with respect to FIG. 3).

Optical character recognition (OCR) 110 may be performed on structured document 102 in order to extract text and positional data 112 from structured document 102. Alternatively, if structured document 102 is already in document format with machine readable text, the text and positional data 112 may be extracted without performing OCR, such as based on copying the machine readable text and positional information directly from the document. The text may include all text from structured document 102 and the positional data may include coordinates of bounding boxes corresponding to locations in structured document 102 from which respective strings of text were extracted. OCR 110 (or another extraction process used to extract text and position data 112) may produce one or more OCR confidence scores 162. For example, OCR confidence score(s) 162 may include one or more numerical values indicating a degree of confidence that the individual steps involved in the extraction process were performed correctly, such as at the document level, the line item level, the individual string/word/character level, and/or the like. Such confidence scores are generally produced by the machine learning model(s) and/or other techniques (e.g., statistical engines) that execute such individual steps, as is known in the art, and are generally based on how accurately the component performing the task was able to perform. Each confidence score may comprise a numerical value, such as normalized to be within a certain range (e.g., 0 to 1).

Positional formatting 130 may be performed on extracted text and positional data 112, such as to format the raw extracted text into a structure that corresponds to the structure in which the text was formatted in the original structured document 102, such as based on the extracted positional data (e.g., bounding box coordinates). In one example, positional formatting 130 involves application of the Layout and Task aware Instruction Prompt (LATIN-Prompt) tool or another similar component that formats one-dimensional text according to two-dimensional positional data. Positional formatting 130 (which may be two-dimensional formatting) produces structured text 132 based on extracted text and positional data 112.

Additionally, a table detection model 140 may be used to extract table data 142 from structured document 102. Table detection model 140 generally represents a machine learning model that is trained to extract start and end coordinates of tables within a structured document. For example, table detection model 140 may be an object detection model, such as a computer vision model, that has been trained through a supervised learning process based on documents labeled with the start and end coordinates of tables to identify such coordinates in a given input document. In some embodiments, table detection model 140 is a transformer model, a convolutional neural network, and/or the like. Table data 142 generally includes the start coordinates and end coordinates of each table that was identified by table detection model 140 in structured document 102. Table detection model 140 may output one or more table detection confidence scores 166 in connection with extracting table data 142 from structured document 102, such as indicating a level of confidence in each set of table start and/or end coordinates and/or a document-level confidence for the overall extraction of table data 142. Each table detection confidence score 166 may comprise a numerical value, such as normalized to be within a certain range (e.g., 0 to 1).

Table data 142 is used in conjunction with structured text 132 to produce table-tagged structured text 134. For example, a table start tag may be added to each location in the structured text that corresponds to the coordinates of the start of a table indicated in table data 142 and a table end tag may be added to each location in the structured text that corresponds to the coordinates of the end of a table indicated in table data 142. The table start and end tags may, for example, be in the form of special text tokens and may be indicated by certain characters such as brackets (e.g., [table start] and [table end]). An example of generating table-tagged structured text is included and described in more detail below with respect to FIG. 3.

Table tagged-structured text 134 is provided to a labeling model 150 along with a labeling model prompt 136. Labeling model 150 generally represents a natural language processing machine learning model such as a large language model (LLM) that has been trained to generate outputs based on natural language inputs. In one example, labeling model 150 is a Generative Pre-trained Transformer (GPT) model. Labeling model 150 may have been trained in advance based on a large amount of natural language training data, and may have a large number (e.g., millions) of parameters.

Labeling model prompt 136 may include a natural language prompt instructing labeling model 150 to generate a label based on table-tagged structured text 134, such as including context and/or instructions to assist labeling model 150 in the task. For example, labeling model prompt 136 may include a system message stating that labeling model 150 is to act as an expert parsing data from documents, and instructing labeling model 150 to carefully read and analyze the information in the input document and extract a particular type of information (e.g., transaction information). Labeling model prompt 136 may include a schematic instruction, such as specifying a schema to which an output from labeling model 150 is to correspond. In one example, such a schema includes a structured object format such as JavaScript Object Notation (JSON) object format specifying a list of variables that labeling model 150 is to populate with values extracted from the input document. For instance, a schematic instruction may specify that labeling model 150 is to populate a JSON object with the following information for each transaction identified in the input document: a date of the transaction, a description of the transaction, a withdrawal amount (e.g., if the transaction amount is removed from the account), a deposit amount (e.g., if the transaction amount is added to the account), an account balance, and/or the like. Labeling model prompt 136 may further include additional instructions, such as specifying that labeling model 150 should not include a variable in the output label if a value for that variable is not extracted from the input document (e.g., “if the information is not present do not include the corresponding key”). The output structured object (e.g., JSON object) may include a plurality of keys and values, where each key corresponds to the name of a variable (e.g., date) and the value corresponding to each key is the value extracted for that variable from the input document (e.g., Jan. 1, 2024). Labeling model prompt 136 may further indicate a document type of the input table-tagged structured text 134, such as informing labeling model 150 that the input document comprises structured table-tagged OCR-generated text.

Labeling model 150 outputs a model-generated ground truth label 152 in response to labeling model prompt 136 and table-tagged structured text 134. For example, model-generated ground truth label 152 may include one or more values extracted from table tagged-structured text 134, such as according to the instructions in labeling model prompt 136. In one example, model-generated ground truth label 152 comprises a structured object (e.g., JSON object) including one or more keys (e.g., variable names) associated with a corresponding one or more values that were extracted for those variables from table-tagged structured text 134. For instance, model-generated ground truth label 152 may include the following key-value pairs: {date: Jan. 1, 2024}, {description: ABC fuel}, {withdrawal amount: 42.00}, {balance: 1024.00}.

Labeling model 150 may output one or more labeling confidence scores 164 in connection with generating model-generated ground truth label 152, such as indicating a level of confidence associated with extracting each value and/or line item, and/or a document-level confidence score associated with the entire process of generating model-generated ground truth label 152.

Model-generated ground truth label 152 may be used at model training 170 to train an item extraction machine learning model, as described in more detail below with respect to FIG. 2. For example, table-tagged structured text 134 may be labeled with model-generated ground truth label 152 in order to generate a labeled training data instance for use in model training 170. The item extraction machine learning model may be a smaller, more domain specific machine learning model, such as having a smaller number of tunable parameters than labeling model 150, that is trained or fine-tuned specifically for extracting items from structured documents. Furthermore confidence score(s) 162, 164, and/or 166 may be used in connection with model training 170, such as to filter out training data instances with labels associated with low confidence scores (e.g., by only using training data instance associated with confidence scores above a threshold for model training 170) and/or during training, such as weighting training data instances differently according to confidence score(s) and/or otherwise factoring such confidence scores into an object function used in model training 170.

Using Automatically-Generated Training Data to Train an Item Extraction Machine Learning Model through a Noise-Aware Supervised Learning Process

FIG. 2 depicts an example workflow 200 for using automatically generated labeled training data to train an item extraction machine learning model through a supervised learning process that prevents model hallucinations, according to embodiments of the present disclosure. It is noted that references herein to training and/or re-training may, in some embodiments, refer to fine-tuning.

Workflow 200 includes table-tagged structured text 134, model-generated ground truth label 152, structured document 102, and table data 142 of FIG. 1.

Table-tagged structured text 134 is provided along with a prompt 204 to an item extraction model 250. Item extraction model 250 generally represents a machine learning model that is trained or fine-tuned as described herein to extract items from structured documents. Item extraction model 250 may, for example, be a smaller, more domain-specific model than labeling model 150 of FIG. 1, such as including fewer parameters than labeling model 150 of FIG. 1. In one example, item extraction model 250 is a natural language processing machine learning model such as a large language model (LLM) that has been trained in advance on a training data set including natural language training data, and is fine-tuned using techniques described herein for more targeted item extraction functionality. For example, item extraction model 250 may be an LLM with fewer parameters than an LLM used as labeling model 150, such that item extraction model 250 is lightweight and can be run in a more resource-efficient manner than labeling model 150. In some embodiments, item extraction model 150 is a multimodal LLM that is capable of processing different modes of inputs, such as text, images, audio, and/or the like. Utilizing a multimodal LLM may allow for gaining insights across different modalities, such as text data, positional data, and image embeddings corresponding to a structured document.

In some embodiments, an embedding 212 of structured document 102 is generated, such as using a visual encoder 210, and is provided along with prompt 204 and table-tagged structured text 134 to item extraction model 250. Visual encoder 210 may represent an embedding model, such as an image embedding model, that outputs a vector representation of an input document or image. In one example, visual encoder 210 is a transformer-based vision model. An embedding generally refers to a vector representation of an input that represents the input as a vector in n-dimensional space such that similar inputs are represented by vectors that are close to one another in the n-dimensional space.

Prompt 204 generally represents a natural language prompt that instructs item extraction model 250 to extract one or more items from table-tagged structured text 134. In some embodiments, prompt 204 is similar to labeling model prompt 136 of FIG. 1, but may include less information. For example, prompt 204 may include a schematic instruction similar to that described above with respect to labeling model prompt 136 of FIG. 1. In an embodiment, prompt 204 specifies one or more variables for which item extraction model 250 is to extract values, such as specifying a structured object format (e.g., JSON object) that item extraction model 250 is to populate with values extracted from table-tagged structured text 134. Prompt 204 may or may not include a system message instructing item extraction model 250 of its role (e.g., as an expert parsing data from documents that is to carefully read and analyze the information in the input document and extract certain types of information, such as transaction information). For example, such a system message may be excluded in some embodiments because item extraction model 250 is fine-tuned for a particular purpose and does not necessarily need to be informed of its role in a prompt. Prompt 204 also may or may not include additional instructions (e.g., instructing item extraction model 250 not to include a key in the output if a corresponding value for the key was not extracted from the input document) and/or a document type (e.g., indicating that the input document is in the form of structured table-tagged OCR text).

Item extraction model 250 may be a neural network (e.g., a large language model). Neural networks generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-matrix multiplication. In some cases, a neural network comprises one or more aggregation layers, such as a softmax layer. A shallow neural network generally includes only a small number of “hidden” layers between an input layer and an output layer. By contrast, a deep neural network (DNN) generally includes a larger number of hidden layers.

In some embodiments, training of item extraction model 250 is a supervised learning process that involves providing training inputs (e.g., table tagged structured text 134, prompt 204, and, in some embodiments, embedding 212) as inputs to item extraction model 250. Item extraction model 250 processes the training inputs and produces outputs (e.g., generated text containing values extracted from table-tagged structured text 134 in a structured format, such as based on prompt 204 and/or embedding 212) based on the training inputs. The outputs are compared to the labels associated with the training inputs (e.g., labeling-model-generated ground truth label 152), such as at evaluation 260, to determine the accuracy of the model predictions, and parameters of item extraction model 250 are iteratively adjusted (e.g., at model parameter adjustment(s) 270) until one or more conditions are met. For instance, the one or more conditions may relate to an objective function (e.g., a cost function or loss function) for optimizing one or more variables (e.g., relating to model accuracy, conformity of outputs to a schema, whether outputs are present within tables in the input document, and/or the like). In some embodiments, the conditions may relate to whether the predictions produced by the model based on the training inputs match the labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art. In some embodiments, such a training process has been performed for item extraction model 250 in advance, such as based on a large training data set that is not specific to a domain or purpose for which item extraction model 250 is to be used in embodiments of the present disclosure, and the process described with respect to workflow 200 is used to fine-tune item extraction model 250 for the domain or purpose for which item extraction model 250 is to be used in embodiments of the present disclosure.

In one embodiment, evaluation 260 involves evaluating an objective function that includes one or more components related to comparing output 252 to model-generated ground truth label 152, one or more components related to confidence score(s) 162, 164, and/or 166 (e.g., weighting training data differently according to confidence scores), one or more components related to whether output 252 conforms to a schema (e.g., specified in prompt 204 and/or model generated ground truth label 152), one or more components related to whether the values in output 252 are present within one or more tables in the input document (e.g., based on table start and end tags included in table-tagged structured text 134 and/or based on table data 142), and/or the like.

In one example, an objective function penalizes training data instances associated with low confidence scores, such as weighting such training data instances less highly or severely than other training data instances associated with higher confidence scores. For example, an aggregation of the OCR confidence score 162 (e.g., produced by OCR 110 of FIG. 1), the labeling confidence score 164 (e.g., produced by labeling model 150 of FIG. 1), and/or the table detection confidence score (e.g., produced by table detection model 140 of FIG. 1) associated with a particular label or part of a label (e.g., particular value in a label) may be aggregated (e.g., averaged or otherwise combined). The aggregated confidence score for a given label or part of a label may be used to determine whether that label or part of a label is to be used for model training. For example, labels or parts of labels with aggregated confidence scores below a threshold may be excluded from the training process, while labels or parts of labels with aggregated confidence scores above the threshold may be used in the training process. Furthermore, the aggregated confidence scores of labels and/or parts of labels may be used to weight different training data instances or parts of training data instances differently during training, such as when evaluating an objective function at evaluation 260. For example, a training data instance having a label with a high aggregated confidence score or a part of a training data instance associated with part of a label having a high aggregated confidence score may be weighted more highly than a training data instance having a label with a lower aggregated confidence score or a part of a training data instance associated with part of a label having a lower aggregated confidence score. Thus, techniques described herein account for variations in label noise that may occur with automatically generated labels by utilizing confidence scores associated with the automatic label generation process during training such that the model parameters are affected less by low-confidence training data and affected more by high-confidence training data.

In certain embodiments, an objective function computes loss based on conformity of output 252 to a schema, such as penalizing outputs that do not conform to the schema. The schema may, for example, be a structured object format specified in prompt 204 and/or model-generated ground truth label 152, and may indicate one or more variables for which values are to be extracted from the input document. An output 252 that conforms more closely to the schema (e.g., if the output includes a list of values for variables that match the list of variables in the schema) may result in a smaller magnitude of loss when the objective function is evaluated than would an output that deviates structurally from the schema (e.g., an output that includes a list of values for variables that differ from the list of variables in the schema). Accordingly, techniques described herein reduce model errors and hallucinations by training the model to ensure that outputs correspond to an expected schema.

In some embodiments, an objective function computes loss based on whether output 252 includes values that are present within one or more tables of the input document, such as penalizing outputs that are situated outside of detected tables. For example, if every value in output 252 is present in table-tagged structured text 134 between a respective table start tag and a respective table end tag, then output 252 may incur no additional loss when the objective function is evaluated than would an output that includes one or more values that are not present in table-tagged structured text 134 between a respective table start tag and a respective table end tag. Thus, techniques described herein further reduce model errors by training the model to favor outputs that are extracted from tables present in input documents, as relevant values in structured documents are more commonly present within tables rather than elsewhere in such documents.

An objective function as described herein may include one or more moss functions that compute loss using negative log-likelihood, as is known in the art.

Model parameter adjustment(s) 270 generally involves adjusting one or more parameters of item extraction model 250 based on evaluation 260. For example, model parameters may be iteratively adjusted as the training process is performed over a series of iterations in order to optimize the objective function. The use of embeddings, such as embedding 212 of structured document 102, as inputs during the training process allows item extraction model 250 to learn which part of the latent representations functionally relates to the target outputs such that item extraction model 250 will treat structured documents having similar embeddings (e.g., embeddings that are within a threshold distance of one another based on a similarity measure such as cosine similarity) in a similar manner. As a result of the training process described herein, the trained item extraction model 250 may perform with a high level of accuracy and efficiency across a wide variety of structured document types and with minimal or no hallucinations. Furthermore the use of embeddings that are generated based on images of structured documents allows item extraction model 250 to learn from an additional modality of input signal beyond text and positional information, such as in order to gain additional insights into a structured document based on an embedding that represents the visual appearance of the document.

For example, once trained, item extraction model 250 may be used to extract information from structured documents, such as documents imported or provided by users of a software application. In one example, a user imports a structured document (e.g., bank statement), and initiates an application feature to extract certain information (e.g., transaction data) from the structured document. Text and positional data may be extracted from the structured document (e.g., using OCR) and structured text may be generated by structuring the raw extracted text based on the extracted positional data. A table detection model may then be used to detect table start and end coordinates in the structured documents, and the table start and end coordinates may be used to add table start and end tags to the structured text. The table-tagged structured text may then be provided to the trained item extraction model 250, such as along with a prompt similar to prompt 204 and, in some embodiments, an image embedding of the structured document (e.g., generated using visual encoder 210). The trained item extraction model 250 may then output structured text containing one or more values extracted from the input table-tagged structured text (e.g., details of one or more transactions), such as in accordance with instructions included in the prompt and based on the provided embedding. The one or more values may, for example, be output in the form a structured data object (e.g., JSON object) including one or more keys corresponding to particular variables, with each key being associated with a value that was extracted from the input document for the corresponding variable. The output from the trained item extraction model 250 may be used in one or more downstream tasks, such as within the software application. In one example, an output from the trained item extraction model 250 is used to perform software functionality related to transaction reconciliation (e.g., assigning transactions to specific categories or accounts associated with a user).

### Generating Structured Text

FIG. 3 an example workflow 300 for automatically generating structured text in connection with using automatically generated labeled training data to train an item extraction machine learning model, according to embodiments of the present disclosure.

In workflow 300, a structured document 310 includes text that is structured into various portions of the page, such as within regions separated by lines, spaces, and/or other elements. The text in structured document 310 may, for example, not be in a machine-readable form, such as if structured document 310 is an image of a document that was scanned or photographed. In the depicted example, structured document 310 includes a summary of accounts, such as associated with a user's bank, and includes details of transactions associated with the accounts over a certain time period. Structured document 310 may be an example of structured document 102 of FIGS. 1-2.

OCR 312 is performed on structured document 310 to produce raw extracted text 320.

Raw extracted text 320 includes only the individual text items (e.g., words, phrases, utterances, tokens, strings, and/or the like) extracted from structured document 310, with the text items being listed one after another without any formatting. OCR 312 may be an example of OCR 110 of FIG. 1, and raw extracted text 320 may be an example of the extracted text in extracted text and positional data 112 of FIG. 1.

Positional formatting and table tagging 322 is performed on raw structured text 320 in order to produce structured text 330. Structured text 330 includes the text from raw extracted text 320 formatted according to the positional data extracted from structured document 310 through OCR 312, such that structured text 330 has a similar positional structure to structured document 310 without the lines, tables, fonts, sizes, and/or other visual elements of the original structured document 310. For example structured text 220 may include raw text that is spaced, indented, and/or otherwise structured according to the positions of such text in the original structured document 310. Furthermore, structured text 330 includes table start tag 332, table end tag 334, table start tag 336, and table end tag 338 indicating the locations in the structured text 330 where tables begin and end in the original structured document 310. For example, the tables themselves may not be included in structured text 330, but the table tags provide indications of which text in structured text 330 is included within a table in the original structured document 310. Positional formatting and table tagging 322 may correspond to positional formatting 130 and use of table data 142 of FIG. 1. Structured text 330 may, for example, correspond to structured text 132 and/or table-tagged structured text 134 of FIG. 1.

### Example Operations for Training an Item Extraction Machine Learning Model

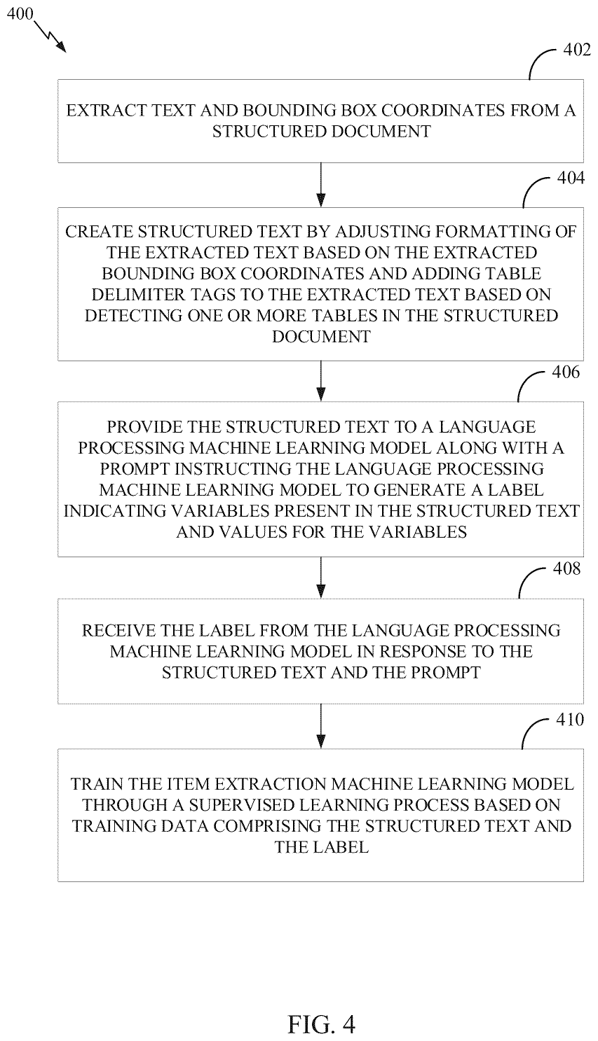

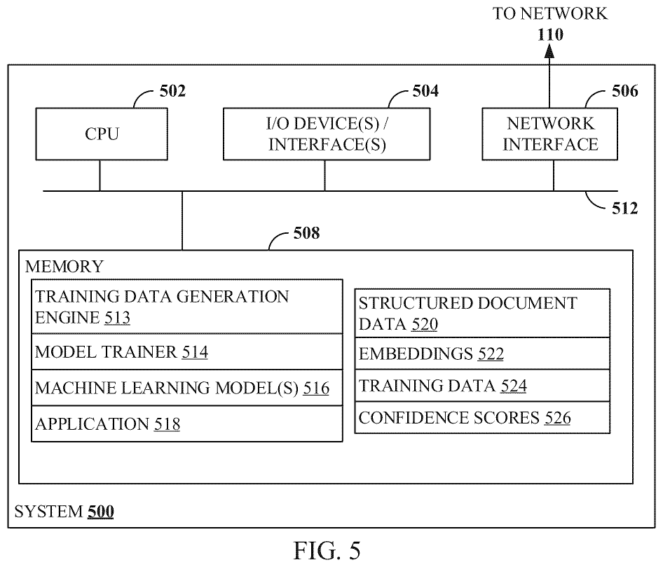

FIG. 4 depicts example operations 400 for training an item extraction machine learning model. For example, operations 400 may be performed by one or more software components running on system 500 of FIG. 5 (described below), and may correspond to functionality described above with respect to FIGS. 1-3.

Operations 400 begin at step 402 with extracting text and bounding box coordinates from a structured document.

Operations 400 continue at step 404, with creating structured text by adjusting formatting of the extracted text based on the extracted bounding box coordinates and adding table delimiter tags to the extracted text based on detecting one or more tables in the structured document. In some embodiments, the detecting of the one or more tables comprises providing the structured document to a table detection machine learning model and receiving bounding coordinates of the one or more tables and corresponding confidence scores from the table detection machine learning model in response to the structured document. In certain embodiments, the table detection machine learning model is a computer vision neural network that accepts an image of the structured document as an input and that is trained for object detection through a supervised learning process.

Operations 400 continue at step 406, with providing the structured text to a language processing machine learning model (e.g., a labeling language processing machine learning model) along with a prompt instructing the language processing machine learning model to generate a label indicating variables present in the structured text and values for the variables. In some embodiments, the prompt specifies that the label is to conform to a schema that specifies a structure for indicating the variables and the values for the variables.

Operations 400 continue at step 408, with receiving the label from the language processing machine learning model in response to the structured text and the prompt.

Operations 400 continue at step 410, with training the item extraction machine learning model through a supervised learning process based on training data comprising the structured text and the label. In some embodiments, the training is based on one or more confidence scores associated with the extracting of the text, the detecting of the one or more tables, or the receiving of the label from the language processing machine learning model. In certain embodiments, the training of the item extraction machine learning model comprises performing a noise aware training process that involves adjusting one or more parameters of the item extraction machine learning model based on evaluating an objective function.

In some embodiments, the evaluating of the objective function comprises computing loss based on computing an aggregation of a text extraction confidence score of the one or more confidence scores and a language processing machine learning model confidence score of the one or more confidence scores. For example, the computed aggregation may be used to determine a weight (e.g., indicating importance) associated with the label during the training. In certain embodiments, the evaluating of the objective function is based on comparing an output produced by the item extraction machine learning model to a schema. In some embodiments, the evaluating of the objective function is based on determining whether the structured text indicates that an output produced by the item extraction machine learning model is contained within a table in the structured document.

Certain embodiments further comprise determining to use the training data for the training of the item extraction machine learning model based on the one or more confidence scores and a confidence score threshold.

In some embodiments, the training of the item extraction machine learning model comprises generating an embedding based on the structured document and providing the embedding along with the structured document as training inputs to the item extraction machine learning model. In certain embodiments, the embedding comprises a multimodal representation vector.

In certain embodiments, the item extraction machine learning model is a compact multimodal large language model (MLLM) having a smaller number of tunable parameters than the language processing machine learning model used to generate the label.

In some embodiments, the training of the item extraction machine learning model comprises instruction fine-tuning of a compact multimodal large language model (MLLM). In certain embodiments, the training data further comprises an instruction prompt.

Notably, operations 400 is just one example with a selection of example steps, but additional methods with more, fewer, and/or different steps are possible based on the disclosure herein.

### Example Computing System

FIG. 5 illustrates an example system 500 with which embodiments of the present disclosure may be implemented. For example, system 500 may be configured to perform operations 400 of FIG. 4 and/or other functionality described herein.

System 500 includes a central processing unit (CPU) 502, one or more I/O device interfaces 504 that may allow for the connection of various I/O devices 514 (e.g., keyboards, displays, mouse devices, pen input, etc.) to the system 500, network interface 506, a memory 508, and an interconnect 512. It is contemplated that one or more components of system 500 may be located remotely and accessed via a network 110. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes training data generation engine 513, which may perform functionality described above with respect to workflow 100 of FIG. 1 for automatically generating labels for use in training an item extraction machine learning model. Memory 508 further includes a model trainer 514, which may perform functionality described above with respect to workflow 200 of FIG. 2 for training an item extraction machine learning model using automatically generated labeled training data. Memory 508 further includes one or more machine learning models 516, which may include labeling model 150 and/or table detection model 140 of FIG. 1, item extraction model 250 and/or visual encoder 210 of FIG. 2, and/or one or more additional machine learning models. Memory 508 further includes an application 518, which may, for example, be a software application that performs operations related to extracting items from structured documents, such as using one or more machine learning models 516 that were trained by model trainer 514 based on training data generated by training data generation engine 513.

Memory 508 includes structured document data 520, which may include structured document 102, extracted text and positional data 112, table data 142, structured text 132, and/or table-tagged structured text 134 of FIG. 1, structured document 310, raw extracted text 320, and/or structured text 330 of FIG. 3, and/or the like. Memory 508 further comprises embeddings 522, which may include embeddings of structured documents such as embedding 212 of FIG. 2. Memory 508 further includes training data 524, which may include model-generated ground truth label 152 in association with table-tagged structured text 134 of FIG. 1, and/or the like. Memory 508 further includes confidence scores 526, which may include confidence score(s) 162, 164, and/or 166 of FIGS. 1 and 2.

It is noted that the components depicted and described with respect to FIG. 5 are included as examples, and functionality described herein may be implemented using more or fewer computing components running on one or more computing devices. In some embodiments, certain components may run on separate computing devices, such as connected via one or more networks. For example, one or more machine learning models and/or model training components may run on one or more remote systems such as cloud servers, and may be accessed via a network.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of training an item extraction machine learning model, comprising:
extracting text and bounding box coordinates from a structured document;
creating structured text by adjusting formatting of the extracted text based on the extracted bounding box coordinates and adding table delimiter tags to the extracted text based on detecting one or more tables in the structured document;
providing the structured text to a language processing machine learning model along with a prompt instructing the language processing machine learning model to generate a label indicating variables present in the structured text and values for the variables;
receiving the label from the language processing machine learning model in response to the structured text and the prompt; and
training the item extraction machine learning model through a supervised learning process based on training data comprising the structured text and the label.

2. The method of claim 1, wherein the training is based on one or more confidence scores associated with the extracting of the text, the detecting of the one or more tables, or the receiving of the label from the language processing machine learning model.

3. The method of claim 2, wherein the training of the item extraction machine learning model comprises performing a noise aware training process that involves adjusting one or more parameters of the item extraction machine learning model based on evaluating an objective function.

4. The method of claim 3, wherein the evaluating of the objective function comprises computing loss based on computing an aggregation of a text extraction confidence score of the one or more confidence scores and a language processing machine learning model confidence score of the one or more confidence scores, wherein the computed aggregation is used to determine a weight associated with the label during the training.

5. The method of claim 3, wherein the evaluating of the objective function is based on comparing an output produced by the language processing machine learning model to a schema.

6. The method of claim 3, wherein the evaluating of the objective function is based on determining whether the structured text indicates that an output produced by the language processing machine learning model is contained within a table in the structured document.

7. The method of claim 2, further comprising determining to use the training data for the training of the item extraction machine learning model based on the one or more confidence scores and a confidence score threshold.

8. The method of claim 1, wherein the detecting of the one or more tables comprises providing the structured document to a table detection machine learning model and receiving bounding coordinates of the one or more tables and corresponding confidence scores from the table detection machine learning model in response to the structured document.

9. The method of claim 8, wherein the table detection machine learning model is a computer vision neural network that accepts an image of the structured document as an input and that is trained for object detection through a supervised learning process.

10. The method of claim 1, wherein the prompt specifies that the label is to conform to a schema that specifies a structure for indicating the variables and the values for the variables.

11. The method of claim 1, wherein the training of the item extraction machine learning model comprises generating an embedding based on the structured document and providing the embedding along with the structured document as training inputs to the item extraction machine learning model, wherein the embedding comprises a multimodal representation vector.

12. The method of claim 1, wherein the item extraction machine learning model is a compact multimodal large language model (MLLM) having a smaller number of tunable parameters than the language processing machine learning model used to generate the label.

13. The method of claim 1, wherein the training of the item extraction machine learning model comprises instruction fine-tuning of a compact multimodal large language model (MLLM).

14. The method of claim 1, wherein the training data further comprises an instruction prompt.

15. A system for training an item extraction machine learning model, comprising:
one or more processors; and
a memory comprising instructions that, when executed by the one or more processors, cause the system to:
extract text and bounding box coordinates from a structured document;
create structured text by adjusting formatting of the extracted text based on the extracted bounding box coordinates and adding table delimiter tags to the extracted text based on detecting one or more tables in the structured document;
provide the structured text to a language processing machine learning model along with a prompt instructing the language processing machine learning model to generate a label indicating variables present in the structured text and values for the variables;
receive the label from the language processing machine learning model in response to the structured text and the prompt; and
train the item extraction machine learning model through a supervised learning process based on training data comprising the structured text and the label.

16. The system of claim 15, wherein the training is based on one or more confidence scores associated with the extracting of the text, the detecting of the one or more tables, or the receiving of the label from the language processing machine learning model.

17. The system of claim 16, wherein the training of the item extraction machine learning model comprises performing a noise aware training process that involves adjusting one or more parameters of the item extraction machine learning model based on evaluating an objective function.

18. The system of claim 17, wherein the evaluating of the objective function comprises computing loss based on computing an aggregation of a text extraction confidence score of the one or more confidence scores and a language processing machine learning model confidence score of the one or more confidence scores, wherein the computed aggregation is used to determine a weight associated with the label during the training.

19. The system of claim 17, wherein the evaluating of the objective function is based on comparing an output produced by the language processing machine learning model to a schema.

20. A non-transitory computer readable medium comprising instructions that, when executed by one or more processors of a computing system, cause the computing system to:
extract text and bounding box coordinates from a structured document;
create structured text by adjusting formatting of the extracted text based on the extracted bounding box coordinates and adding table delimiter tags to the extracted text based on detecting one or more tables in the structured document;
provide the structured text to a language processing machine learning model along with a prompt instructing the language processing machine learning model to generate a label indicating variables present in the structured text and values for the variables;
receive the label from the language processing machine learning model in response to the structured text and the prompt; and
train an item extraction machine learning model through a supervised learning process based on training data comprising the structured text and the label.
